(19) United States
(12) Patent Application Publication
(10) Pub. No.: US 2010/0185389 A1
(43) Pub. Date: Jul. 22, 2010

(54) GPS-based vehicle alert and control system

(76) Inventor: Michael Glenn Woodard, Northport, AL (US)

Correspondence Address: LITMAN LAW OFFICES, LTD., POST OFFICE BOX 41200, SOUTH STATION, ARLINGTON, VA, 22204, US

(21) Appl. No.: 12/461,622

(22) Filed: Aug. 18, 2009

Related U.S. Application Data
(60) Provisional application No. 61/205,482, filed on Jan. 21, 2009.

(51) Int. Cl. G01C 21/26

(52) U.S. Cl. 701/208

(57) ABSTRACT

The GPS-based vehicle alert and control system and method provides added fuel efficiency and safety for a global positioning system (GPS) equipped vehicle, such as an automobile, truck, airplane, boat or the like. In operation, the system receives a GPS signal to generate a set of vehicle position coordinates, which indicate the present location of the vehicle. A set of map data for a region about the vehicle position coordinates is then generated. Utilizing a constantly updated position of the vehicle, the system calculates a velocity of the vehicle and a projected path of the vehicle. At least one position in the projected path of the vehicle in which a change in the velocity of the vehicle is recommended is identified. The system generates an alert signal to the operator of the vehicle, which may be an auditory alarm or a visual alarm displayed on a display, including instructional information.

### CROSS-REFERENCE TO RELATED APPLICATION

This application claims the benefit of U.S. Provisional Patent Application Ser. No. 61/205,482, filed Jan. 21, 2009.

### BACKGROUND OF THE INVENTION

1. Field of the Invention

The present invention relates to vehicle navigational systems and, particularly, towards a global positioning system (GPS)-based vehicle alert and control system for increasing fuel efficiency and safety of the vehicle.

2. Description of the Related Art

Optimization of fuel efficiency of vehicles has become a very important issue for automobile manufacturers and consumers. There is presently a great deal of focus on the manufacture of fuel efficient vehicles through, for example, the development of a lean burn engine or through increasing the efficiency of an engine and an associated transmission.

In the automotive field, it is well known to provide fuel-efficient driving information to a vehicle operator, via a display unit mounted within the vehicle. A conventional system for providing fuel-efficient driving information to the vehicle operator instructs the driver to increase or decrease the speed of the vehicle by displaying uneconomical, semi-economical, and economical display information based upon fuel efficiency and power-related information measured via sensors in the engine or transmission of the vehicle, and further by measuring power-related information acquired from the accelerator and brake pedals.

Such conventional systems classify driving regions as “uneconomical”, “semi-economical” and “economical” according to the degree of acceleration and deceleration for each road section, and further indicate the current fuel efficiency of the vehicle.

Such systems, however, are only capable of applying these criteria to general rectilinear roads. When applied to curved and inclined roads, for example, the reliability of the system is greatly decreased, thus risking the safety of the driver. In the case of a curved road, for example, it is advantageous, in terms of fuel efficiency, to decrease the speed of the vehicle well before the vehicle enters a corner of the curved road, and then slowly decrease the speed until the vehicle passes the corner completely. However, the conventional system described above indicates that the current fuel efficiency is in an economical region if the speed of the vehicle is maintained immediately before the vehicle enters the corner, but indicates that the current fuel efficiency is in a semi-economical or uneconomical region if the speed of the vehicle is decreased before the vehicle enters the corner.

Accordingly, in the case where a driver heeds the information that is provided by the system, he or she decreases the speed rapidly when the vehicle completely enters the corner, causing a decrease in fuel efficiency. In the same manner, in the case of an inclined road, it is efficient to acquire sufficient power before the vehicle enters the inclined road and ascend the incline using a momentum generated by the power. However, the conventional system described above is problematic, in that fuel efficiency is decreased because the accelerator is excessively pushed down due to the lack of drive force on the inclined road.

Motor vehicle users are increasingly sensitive to vehicle fuel costs. Environmental consciousness is also another factor that is leading people to search for efficient use of their vehicles and the reduction of fuel consumption. One of the least efficient methods of driving is city driving, which typically includes numerous stops due to traffic lights, heavy traffic, prolonged waits at railroad crossings or draw-bridges, etc. While drivers can receive up-to-date traffic information from radio stations or wireless services, it is often difficult to determine an efficient route based on all the information available. The route with the least amount of traffic may not always be the most fuel efficient route due to other factors such as number of traffic lights, speed limit on portions of the selected route, and the like.

Global positioning system (GPS) based navigation devices are commonly used by drivers to navigate in areas where they may not be familiar with the streets and landmarks. A GPS-based navigation device typically receives positioning data from a satellite, compares the data to a map in its memory and provides the driver with a map of the area and directions for a selected destination. However, GPS-based navigation devices often require a user to undergo a non-trivial learning curve before the device provides value to them (e.g., learning to enter destination address and distance/time optimization parameters). Moreover, drivers are unlikely to use the navigation features to get to destinations they already know, such as the local post-office, bank, grocery store, etc. Thus, even with added navigational information computed and displayed by the system, the driver often does not take the most fuel efficient route, or operate the vehicle in a fuel efficient, or even safe, manner.

Thus, a GPS-based vehicle alert and control system solving the aforementioned problems is desired.

### SUMMARY OF THE INVENTION

The GPS-based vehicle alert and control system provides added fuel efficiency and safety for a global positioning system (GPS)-equipped vehicle, such as an automobile, truck, airplane, boat or the like. In operation, the GPS-based vehicle alert and control system, which includes a conventional GPS receiver or the like, receives a GPS signal to generate a set of vehicle position coordinates, which indicate the present location of the vehicle. A set of map data for a region about the vehicle position coordinates is then generated, using any suitable type of geographic map generation system or methodology. Preferably, the GPS-based vehicle alert and control system includes a display and a user interface, and the vehicle position is graphically indicated to the user on the display, with the vehicle position being indicated on a standard GPS map grid, generated from the set of map data and also displayed on the display.

Utilizing a constantly updated position of the vehicle, along with a suitable timer or timing circuit, the system calculates a velocity of the vehicle and a projected path of the vehicle, with the velocity and projected path preferably also being displayed to the user on the display, overlaid on the graphical map display.

At least one position in the path of the vehicle is then identified by the system when the system calculates that a recommendation for alteration of speed, course or power may be advisable. For example, for an automobile driving on a road, if a graded curve lies ahead of the vehicle along the vehicle's projected path on the road, the system calculates the distance to the graded curve and also calculates appropriate changes to the velocity of the vehicle. In this example, the vehicle should slow its speed and be prepared to change direction, with the slow in speed being both as a safety measure and also to increase fuel efficiency (and wear on the vehicle brakes). GPS-enabled systems with updated details regarding road conditions and the like are known in the art, and such information, such as curves and grades in roads, may be used by the system in order to calculate recommendations to the driver regarding changes in velocity, including changes in speed and direction, and when to apply such changes.

The system generates an alert signal to the operator of the vehicle, which may be an auditory alarm or, preferably, is a visual alarm displayed on the display of the system, including instructional information, such as navigational and driving instructions, and indicators of the coming road conditions. Alternatively, the system may also generate control signals, with the system automatically applying the vehicle brakes or, depending upon the situation, actuating the vehicle's accelerator. It should be understood that these are only examples of the type of control signals which may be generated. It should be understood that the recommendations made to the user, as well as the control signals, preferably cover a very broad range of vehicle operation, such as, for example, advising the user to coast when in a downhill situation, or advising the user (or generating an automatic control signal) to change gears. Further, rather than manual actuation of the accelerator, as an example, the system may adjust fuel flow or energy flow within the vehicle. The user preferably may select to have this automatic system turned on or off, and may also select the degree to which the system provides control signals.

The overall system includes a processor or controller, which may be any suitable type of processor or controller, such as a programmable logic controller, coupled with computer readable memory, for storing the set of map data, the updated navigational data, instructional information and the like, and a GPS transceiver or the like. Additionally, as noted above, a display is preferably further provided, along with a user interface, allowing the user to input information to the system, and an alarm or alert (which may be integrated with the display, as noted above), and a guidance interface, which may be a separate unit which either provides instructional information to the user, either by graphical display and/or auditory signals, or is interfaced with the systems of the vehicle for generating automatic control signals, as described above.

In addition to calculating changes to course and velocity based upon the vehicle's updated position, velocity and the projected path of the vehicle, other external information may be received by the GPS transceiver, such as traffic information, weather information and the like. It should be understood that these are mere examples, and that any necessary or desired external information may be received by the system.

These and other features of the present invention will become readily apparent upon further review of the following specification and drawings.

### BRIEF DESCRIPTION OF THE DRAWINGS

FIG. 1 is a diagrammatic view of a GPS-based vehicle alert and control system according to the present invention.

FIG. 2 is an exemplary map display of a GPS-based vehicle alert and control system according to the present invention.

FIG. 3 is a simplified block diagram of the GPS-based vehicle alert and control system according to the present invention.

FIG. 4 is a flowchart showing operation of a GPS-based vehicle alert and control system according to the present invention.

Similar reference characters denote corresponding features consistently throughout the attached drawings.

### DETAILED DESCRIPTION OF THE PREFERRED EMBODIMENTS

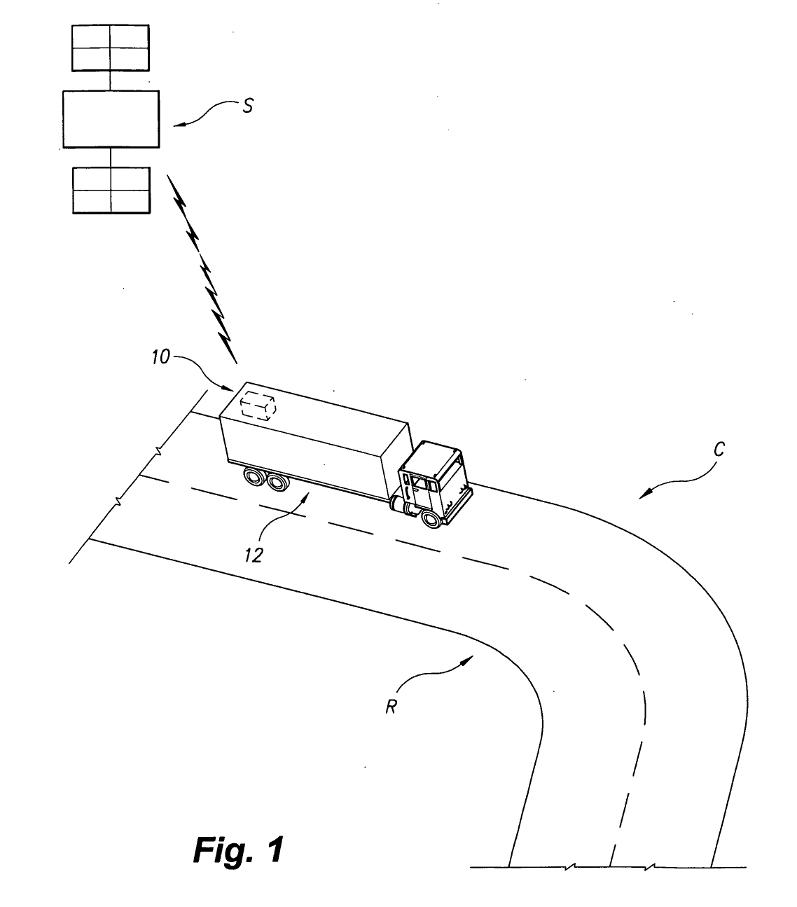

Referring to FIGS. 1-3, the GPS-based vehicle alert and control system 10 provides added fuel efficiency and safety for a global positioning system (GPS) equipped vehicle, such as an automobile, truck, airplane, boat or the like. In FIG. 1, an exemplary automobile 12 is shown driving on road R, approaching a curve in the road C. Automobile 12 is equipped with the GPS-based vehicle alert and control system 10, which receives GPS positioning signals from GPS satellite S. It should be understood that automobile 12, the road R, and the curve C are shown for exemplary purposes only. Additionally, it should be understood that any suitable type of GPS transceiver assembly, or any other suitable type of tracking system, may be utilized in system 10.

In operation, the GPS-based vehicle alert and control system 10, which includes a conventional GPS receiver, transceiver or the like, receives a GPS signal from satellite S (or any other suitable transmitter or repeater) to generate a set of vehicle position coordinates, which indicate the present location of the vehicle 12. A set of map data for a region about the vehicle position coordinates is then generated, using any suitable type of geographic map generation system or methodology. As will be described in detail below, preferably, the GPS-based vehicle alert and control system 10 includes a display 20 and a user interface 18, and the vehicle position is graphically indicated to the user on the display 20, with the vehicle position being indicated on a standard GPS map grid, generated from the set of map data and also displayed on the display 20.

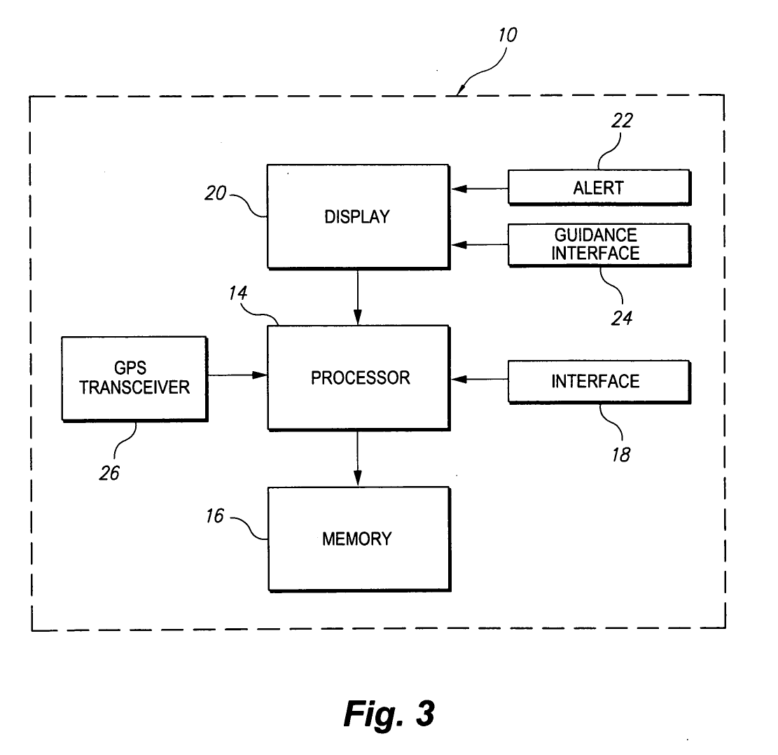

GPS-enabled navigations systems are known in the art. Examples of such systems include U.S. Pat. Nos. 7,493,208 and 6,853,911, each of which is hereby incorporated by reference in its entirety. FIG. 3 illustrates a simplified overview of the system components of system 10, including a processor or controller 14, which may be any suitable type of processor or controller, such as a programmable logic controller, coupled with computer readable memory 16, which may be any suitable type of computer-readable memory, for storing the set of map data, updated navigational data, instructional information or the like, and a GPS transceiver 26 or the like. Additionally, as noted above, a display 20 is preferably further provided, along with a user interface 18, allowing the user to input information to the system, and an alarm or alert 22 (which may be integrated with the display 20), and a guidance interface 24, which may be a separate unit which either provides instructional information to the user, either by graphical display and/or auditory signals, or is interfaced with the systems of the vehicle for generating automatic control signals, as will be described in detail below.

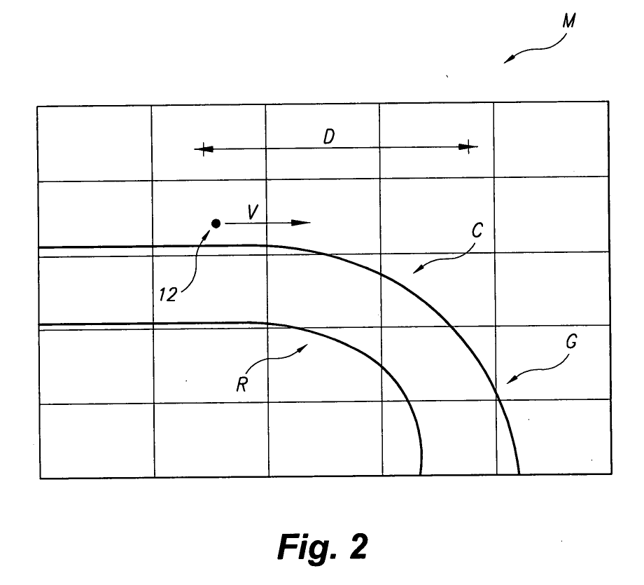

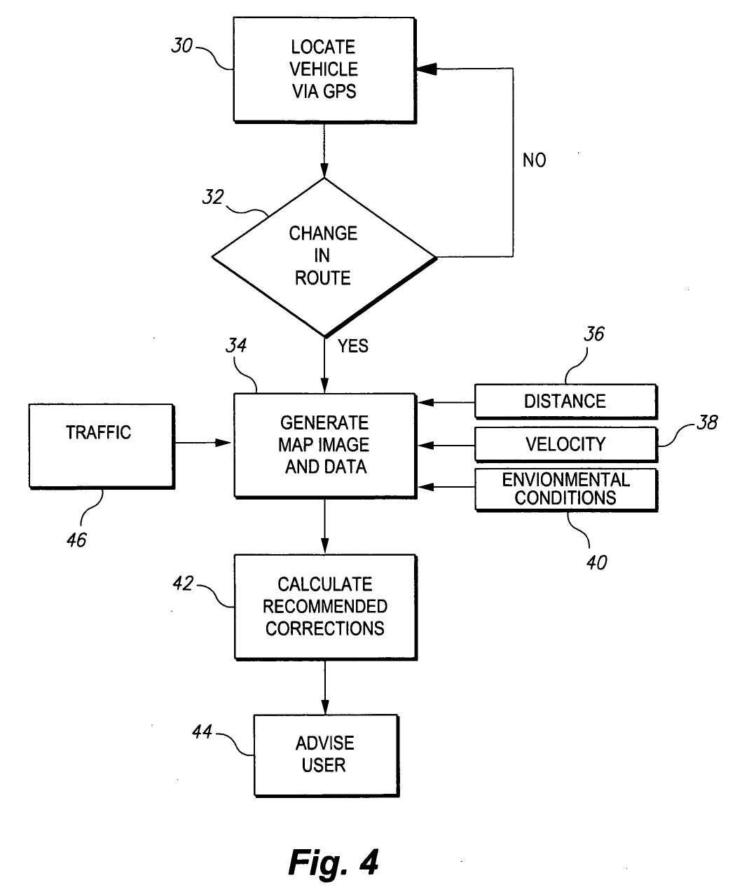

FIG. 2 illustrates an exemplary map display, displayed to the user on display 20, which is generated from the set of map data. System 10 receives constantly updated position data from satellite S, via GPS transceiver 26, and also receives map data for the surrounding geographical area (step 30 in FIG. 4). Utilizing a constantly updated position of the vehicle 12, along with a suitable timer or timing circuit, as is well known, the system 10 calculates a velocity V of the vehicle 12 and a projected path of the vehicle 12, with the velocity V and projected path preferably also being displayed to the user on the display 20, overlaid on the graphical map display M, as shown in FIG. 2. Display 20 may be an interactive display (e.g., touch sensitive) and/or provide soft keys, as well. It should be understood that the terms “map” and “map data” are herein defined to include any desired geographical or navigational details. For example, the map data may include data on road elevations and grades, which is typically not found on conventional paper maps for use in automobiles. Similarly, for non-automobile utilizations, such as in aircraft, for example, information regarding altitudes, airspace limitations and ground hazards may be included, as examples.

At step 32, the system 10 analyzes whether changing travel conditions in the path of the vehicle should cause the driver to be alerted to a recommended change in vehicle velocity. In the example of FIGS. 1 and 2, a graded curve C exists in the road R, ahead of vehicle 12. It should be understood that this is only an example of a condition requiring a change in vehicle velocity. Other examples include traffic congestion, a traffic signal, or inclement weather. The latter may affect other types of vehicles equipped with system 10, such as a boat or airplane. It should be understood that any necessary or desired external information may be received by the system. For example, a boat may require external information on wave and water currents in addition to weather updates.

When at least one position in the path of the vehicle 12 requiring a change in the velocity of the vehicle 12 is identified by the system 10 (step 32), the system calculates the distance D from the position of interest (36 in FIG. 4), updates the vehicle velocity V calculation (38 in FIG. 4), and may receive updated traffic conditions 46, updated environmental conditions 40, such as weather conditions (wind speed, precipitation, etc.) or any other relevant data, with the set of map data updated and generated for the user at step 34. As noted above, any desired or necessary environmental or external conditions may be received by system 10. For example, in addition to what is stated above, information regarding barometric pressure, wind direction, wave size, current speeds and direction, tide current speeds and directions, water current speed and directions, etc. may all be received by system 10 and be used in calculating recommended course, power or speed corrections.

In the present example, for an automobile 12 driving on road R, if a graded curve C lies ahead of the vehicle 12 along the vehicle's projected path on the road R, the system 10 calculates the distance D to the graded curve C and also calculates appropriate changes to the velocity V of the vehicle 12 (step 42). In this example, the vehicle 12 should slow its speed and be prepared to change direction, with the slow in speed being both a safety measure and also serving to increase fuel efficiency (and wear on the vehicle brakes). As noted above, GPS-enabled systems with updated details regarding road conditions and the like are known in the art, and such information, such as curves and grades in roads, may be used by the present system 10 in order to calculate recommendations to the driver regarding changes in velocity, including changes in speed and direction, and when to apply such changes.

The system 10 generates an alert signal to the operator of the vehicle at step 44, which may be an auditory alarm or, preferably, a visual alarm displayed on the display 20 of the system, including instructional information, such as navigational and driving instructions, and indicators of the coming road conditions. An example of an alarm or alert may include a beep or other tone generated by an auditory alarm, to alert the driver to look at display 20, coupled with the updated map data and map display M, with additional instructional information, such as “Slow vehicle to 20 miles per hour,” being either displayed and/or spoken aloud to the driver.

Alternatively, the system 10 may also generate control signals, with the system automatically applying the vehicle brakes or, depending upon the situation, actuating the vehicle's accelerator. The user preferably may select to have this automatic system turned on or off, and may also select the degree to which the system provides control signals. GPS-based systems including navigational information and control of vehicle systems are known in the art. Examples of such systems include U.S. Pat. Nos. 7,447,573; 5,774,069; and 7,340,329, each of which is hereby incorporated by reference in its entirety. It should be understood that, as noted above, the actuation or application of the vehicle's brakes or accelerator are stated above for exemplary purposes only. It should be understood that the recommendations made to the user, as well as the control signals, preferably cover a very broad range of vehicle operation, such as, for example, advising the user to coast when in a downhill situation, or advising the user (or generating an automatic control signal) to change gears. Further, rather than manual actuation of the accelerator, as an example, the system may adjust fuel flow or energy flow within the vehicle.

In the example given above for FIGS. 1 and 2, vehicle 12 approaches a graded curve C in the road C, requiring a decrease in vehicle speed and a change in direction, which is indicated to the driver, both to increase fuel efficiency and also to increase the safety of the driver. Another example includes vehicle 12 approaching an intersection. The system 10 calculates distance D to the intersection, the vehicle velocity V, and receives any other pertinent environmental information, such as road condition information, traffic congestion information, and information regarding the present state of traffic signals at the intersection (whether the signal is red, yellow or green, how long the driver has until the light turns red, etc.), and calculates a recommendation to the driver regarding velocity, which is displayed or otherwise transmitted to the driver.

In addition to external information, system 10 may also utilize information, such as the weight, make, model and design of the vehicle, the vehicle's engine, the vehicle's transmission, etc. in order to calculate the most efficient course changes. As another example, the system 10 may be used to improve fuel efficiency on a downhill path. The system 10 may advise the driver (or automatically control the vehicle) to place the vehicle in neutral (or coast in gear) during part of the descent, allowing the vehicle 12 to coast down the hill, unpowered. In order to provide optimal fuel efficiency calculations, factors such as the vehicle's weight may be taken into account, along with aerodynamic considerations and also road conditions. For purposes of safety, a maximum speed may also be calculated, along with recommendations as to when to apply the brakes and when to begin using the accelerator following the descent (or, as described above in detail, other recommendations or control signals regarding power, fuel flow, etc.). In addition to the above-described curved and inclined roads, the present systems can be usefully used in other various road conditions. For example, it can be used when traveling in areas in a city in which a vehicle must stop due to a traffic signal, as noted above, or in areas of traffic congestion. Furthermore, the present system can detect, using the GPS transceiver, any situation in which a rapid increase or decrease of speed is expected, such as a case where the rapid decrease of speed must or could be conducted due to a rapid variation in the road environment, and enable a driver to appropriately respond to the situations, thus improving fuel or energy usage efficiency and safety.

In addition to automobiles, a similar system may be integrated into airplanes and other flying craft, with fuel efficiency being based primarily on the craft's ability to glide and readily alter airspeed. External information for such calculations will include weather data, such as wind speed, data regarding air traffic, the altitude of the airplane and the like. As noted above, a wide variety of external information may be received by system 10, dependent upon the particular needs and desires of the vehicle and the user. Similarly, a boat or other water-based craft could utilize such a system, with wind, current information and updated information regarding other craft in the vicinity being input to the system. Further, in addition to the vehicle advisories and control described above, system 10 may be used for other purposes. For example, memory of the system may be used to record the usage of the system to verify operators' level of adherence to the advisories.

It is to be understood that the present invention is not limited to the embodiments described above, but encompasses any and all embodiments within the scope of the following claims.

I claim:

1. A GPS-based vehicle alert and control method, comprising the steps of:
receiving a GPS signal to generate a set of vehicle position coordinates;
generating a set of map data for a region about the vehicle position coordinates;
calculating a velocity of the vehicle and a projected path of the vehicle;
identifying at least one position in the projected path of the vehicle in which a change in the velocity of the vehicle is recommended; and
generating an alert signal to an operator of the vehicle.

2. The GPS-based vehicle alert and control method as recited in claim 1, further comprising the step of generating a visual map display using the set of map data.

3. The GPS-based vehicle alert and control method as recited in claim 2, further comprising the step of visually displaying on the visual map display the at least one position in the path of the vehicle requiring the change in the velocity of the vehicle, relative to the vehicle.

4. The GPS-based vehicle alert and control method as recited in claim 3, further comprising the step of providing navigational instructions to the operator of the vehicle.

5. The GPS-based vehicle alert and control method as recited in claim 4, further comprising the step of calculating a desired change in the velocity of the vehicle.

6. The GPS-based vehicle alert and control method as recited in claim 5, further comprising the step of selectively generating vehicle control signals for automatically changing the velocity of the vehicle.

7. The GPS-based vehicle alert and control method as recited in claim 6, further comprising the step of receiving a set of external condition data, the calculation of the desired change in the velocity of the vehicle being based upon a present velocity of the vehicle, the at least one position in the path of the vehicle requiring the change in the velocity of the vehicle relative to the vehicle, and the set of external condition data.

8. The GPS-based vehicle alert and control method as recited in claim 7, wherein the step of receiving external condition data includes receiving environmental-based data.

9. The GPS-based vehicle alert and control method as recited in claim 7, wherein the step of receiving external condition data includes receiving traffic-based data.

10. A GPS-based vehicle alert and control method, comprising the steps of:
receiving a GPS signal to generate a set of vehicle position coordinates;
generating a set of map data for a region about the vehicle position coordinates;
calculating a velocity of the vehicle and a projected path of the vehicle;
identifying at least one position in the projected path of the vehicle in which a change in the velocity of the vehicle is recommended;
calculating a desired change in the velocity of the vehicle; and
selectively generating vehicle control signals for automatically changing the velocity of the vehicle.

11. The GPS-based vehicle alert and control method as recited in claim 10, further comprising the step of generating an alert signal to an operator of the vehicle.

12. The GPS-based vehicle alert and control method as recited in claim 11, further comprising the step of generating a visual map display using the set of map data.

13. The GPS-based vehicle alert and control method as recited in claim 12, further comprising the step of visually displaying on the visual map display the at least one position in the path of the vehicle in which the change in the velocity of the vehicle is recommended, relative to the vehicle.

14. The GPS-based vehicle alert and control method as recited in claim 13, further comprising the step of providing navigational instructions to the operator of the vehicle.

15. The GPS-based vehicle alert and control method as recited in claim 14, further comprising the step of receiving a set of external condition data, the calculation of the desired change in the velocity of the vehicle being based upon a present velocity of the vehicle, the at least one position in the path of the vehicle in which the change in the velocity of the vehicle is recommended relative to the vehicle, and the set of external condition data.

16. The GPS-based vehicle alert and control method as recited in claim 15, wherein the step of receiving external condition data includes receiving environmental-based data.

17. The GPS-based vehicle alert and control method as recited in claim 15, wherein the step of receiving external condition data includes receiving traffic-based data.

18. A GPS-based vehicle alert and control system, comprising:
means for receiving a GPS signal to generate a set of vehicle position coordinates;
means for generating a set of map data for a region about the vehicle position coordinates;
means for calculating a velocity of the vehicle a path of the vehicle;
means for identifying at least one position in the projected path of the vehicle in which a change in the velocity of the vehicle is recommended; and
means for generating an alert signal to an operator of the vehicle.

19. The GPS-based vehicle alert and control system as recited in claim 18, further comprising means for generating a visual map display using the set of map data and visually displaying on the visual map display the at least one position in the path of the vehicle requiring the change in the velocity of the vehicle, relative to the vehicle.

20. The GPS-based vehicle alert and control system as recited in claim 19, further comprising:
means for calculating a desired change in the velocity of the vehicle; and
means for selectively generating vehicle control signals for automatically changing the velocity of the vehicle.
